(19) United States
(12) Patent Application Publication
(10) Pub. No.: US 2006/0050382 A1
(43) Pub. Date: Mar. 9, 2006

(54) Method for the protection of 3d screen

(76) Inventors: Uwe Jahrmarkt, Jena (DE); Hans-Jurgen Rossbach, Hermsdorf (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/533,203

(22) PCT Filed: Apr. 7, 2004
(86) PCT No.: PCT/EP04/03695

§ 371 Date: Apr. 28, 2005

(30) Foreign Application Priority Data
Apr. 8, 2003 (DE) 10316733.1

(51) Int. Cl. G02B 27/22

(52) U.S. Cl. 359/462

(57) ABSTRACT

A method for converting a 2D display screen into an autostereoscopic screen and an adapter suitable for effecting such conversion. According to the invention, the fabrication of a 3D display screen suitable for autostereoscopic image display from a 2D display screen originally designed for two-dimensional image display includes: removing the front bezel from the 2D display screen, attaching an adapter with an optical assembly for separating an image displayed on the image display surface into stereoscopic partial images, Aligning the optical assembly relative to the image display surface so that one of the stereoscopic partial images reaches one eye and at least one other stereoscopic partial image reaches the other eye of an observer, who thus has a stereoscopic vision of the image displayed.

### FIELD OF THE INVENTION

The invention relates to a method for converting a 2D display screen into an autostereoscopic display screen, and to an adapter suitable for such conversion that is provided with an optical assembly for separating the images displayed into at least two stereoscopic partial images.

### DESCRIPTION OF PRIOR ART

The fabrication of 3D display screens from commercial 2D display screens is in some cases effected by adding at least one optical assembly to the respective 2D display screen. The said optical assembly is positioned closely in front of the surface (seen from the direction of an observer) on which the image is displayed. Therefore, the mechanical characteristics such as the frame design of the 2D display screen are of great interest to the manufacturers of 3D display screens.

The design of the frame surrounding the image display surface of the 2D display screen is a matter of importance. In the context of the invention described below, this frame is also named a front bezel. It is not always possible to get 2D display screens intended for conversion that have a frame or front bezel of a design that is favorable for adding the optical assembly.

Moreover, for positioning the optical assembly, it is often necessary to adjust it by a defined displacement relative to the image display surface until an autostereoscopic display of adequate quality is achieved. If such an optical assembly, which may, for example, be designed as a wavelength filter array or a defined arrangement of lenticulars, is to be firmly attached in front of the image display surface of a plasma screen of the Pioneer PDP 502 type within its existing frame design, the said frame design does not allow any displacement of the optical assembly, because this frame is immovably fixed with screws to the screen chassis.

### DESCRIPTION OF THE INVENTION

The problem of the invention is to design a method that allows the conversion of a commercial 2D display screen into a 3D display screen suitable for the autostereoscopic display of images with relatively little effort.

According to the invention, this problem is solved by a method for fabricating a 3D display screen suitable for the autostereoscopic display of images from a 2D display screen originally intended for the two-dimensional display of images and having a front bezel surrounding the image display surface, by means of the following process steps:
Removal of the front bezel from the 2D display screen,
Attachment of an adapter provided with an optical assembly for separating an image displayed on the image display surface into stereoscopic partial images, so that the optical assembly covers the image display surface,
Aligning the optical assembly relative to the image display surface so that at least one of the stereoscopic partial images reaches one eye, and at least one other stereoscopic partial image reaches the other eye of an observer, with the observer thus seeing the image displayed as a stereoscopic image.

In other words, the method according to the invention comprises the following steps:
a) Manufacturing a frame of preferably rectangular shape,
b) Attaching to the said frame a front pane comprising at least one optical structure that effects image separation for autostereoscopic display, such attachment being preferably achieved by means of metal spring clips, or by means of an adhesive, and such front pane, with particular preference, not being rigidly fixed at first
c) Removal of the original front bezel from the 2D display screen,
d) Attaching the adapter consisting of the structured front pane and the frame to the chassis of the 2D display screen,
e) Aligning the position of the front pane relative to the image display surface of the 2D display screen, and
f) Rigid fixation of the front pane to the frame.

Aligning the optical assembly with the image display surface can be effected in a first version by varying the position, relative to the image display surface, of the optical assembly jointly with the frame, or in a second version by varying the position of the optical assembly relative to the image display surface and to the frame.

The front pane together with the optical structure makes up the optical assembly for separating an image displayed on the image display surface into at least two stereoscopic partial images.

Separation into partial images may, for example, be implemented in such a way that an image combined from two different perspective views and displayed on the image display surface is separated into two partial images, an image combined from eight perspective views and displayed on the image display surface is separated into two partial images, an image combined from twelve partial images and displayed on the image display surface is separated into four partial images, or similar ways.

The order of steps a) through f) is variable, at least in parts. For example, steps b) and c) may be carried out in the reverse order.

To give the 3D display screen thus fabricated a pleasing look, the method according to the invention can be extended by the following step:
g) Attaching the front bezel that was removed in the first step, or another, separately made front bezel to cover the margin of the adapter.

Step e) is preferably carried out as follows:
Display of a test image on the image display surface of the 2D display screen, in which the test image preferably is an image combined from n (n≧2) views arranged in rows and/or columns, and in which exactly (n-1) of the views correspond to a completely black area each and exactly one view corresponds to a completely white or completely blue or completely green or completely red area;
continuous displacement of the position of the front pane relative to the image display surface of the 2D display screen, with simultaneous visual or opto-electronic inspection of the monocular images from an arbitrary but permanent monocular viewing position until the said displacement of the front pane relative to the image display surface of the 2D display screen has led to a relative position in which a white or blue or green or red area of maximum extension is visible in the monocular image seen from the said monocular viewing position.

Visual inspection means, in particular, observation by an operator; opto-electronic inspection means, in particular, observation by means of a video camera or similar device.

Furthermore, the test images to be used preferably correspond to the optical structure. If, for example, a lenticular screen provided with a multitude of vertical cylindrical lenses is used, about the same number of image information bits from the n views mentioned above should be shown below each cylindrical lens. Thus, a lenticular image combined from eight views as known to those skilled in the art should preferably be a test image composed of eight views, too.

It is just as well possible to use totally different kinds of test images, e.g. such consisting of elements of linear or cuboid shape.

The optical structure may be, for example, a wavelength filter array laminated to or printed on the front pane, a lenticular screen, or a barrier screen. This enumeration is non-exclusive and not meant as a restriction of the idea of the invention. Even holographic optical elements (HOEs) may be employed.

The front pane is preferably a protective pane of shatterproof glass provided with a planar, electrically conductive structure that shields observers from electromagnetic radiation emanating from the image display surface, which should be considered especially where the image display surface is a plasma screen.

In such a case, it will usually be of advantage to provide an electrical contact between the front bezel optionally attached in step g), the electrically conductive structure and the chassis of the original 2D display screen.

In a particularly preferable embodiment, the optical structure is a wavelength filter array, consisting of a suitably exposed and processed film sheet laminated to the front pane. Examples of the design of such a wavelength filter array are described in DE 201 21 318 U and elsewhere.

According to step a) of the above embodiments of the invented method, the frame is provided with a defined profile depth, preferably between 2 mm and 30 mm, so that the front pane with the optical structure that effects image separation is held at a defined distance from the image display surface of the 2D display screen. Depending on the application, the said profile depth may also be greater than 30 mm.

In addition, it is preferable in step b) to insert a strip of expanded rubber between the front pane and the frame to prevent slippage.

The invention further relates to an adapter for making a 3D display screen suitable for the autostereoscopic display of images, from a 2D display screen originally intended for two-dimensional display of images, according to the process steps described above, the said 2D display screen being provided with an image display surface and a front bezel surrounding the image display surface, the said adapter comprising
a frame whose geometric extension parallel to the image display surface approximately equals the extension of the front bezel of the 2D display screen,
a front pane provided with an optical structure in the form of an array of wavelength filters or lenticulars or in the form of a barrier screen for separating an image displayed on the image display surface into stereoscopic partial images, thus implementing image separation for autostereoscopic display, in which
the front pane is connected to the frame by means of fastening, and in which the frame surrounds the front pane at its margin.

The frame may be made from sections, preferably aluminum sections arranged in a polygonal, preferably rectangular form. The front pane, which comprises at least one optical structure effecting image separation for autostereoscopic display, may be fastened to the frame in an either slack or rigid manner, the means of fastening preferably consisting in metal spring clips.

In a special configuration, the frame may consist of a material having two adhesive surfaces, with one adhesive side being used for fixation to the outer rim of the screen and the other adhesive side holding the front pane.

The frame and the front pane jointly constitute the adapter. In addition, a front bezel may be provided to conceal the margin of the adapter attached to the 2D display screen.

In another embodiment of the adapter according to the invention, the optical structure that effects image separation for autostereoscopic display is designed as an array of wavelength filters or lenticulars or as a barrier screen, laminated to or printed on the front pane. It is understood that other embodiments, e.g., such using HOEs, are also feasible.

It is of advantage if the frame is provided with a defined profile depth, preferably between 2 mm and 30 mm, so that the front pane with the optical structure laminated to it or printed on it is held at a defined distance from the image display surface. Depending on the application, the said profile depth may also be greater than 30 mm, of course.

Between the front pane and the frame, an intermediate lining of expanded rubber may be arranged, which has the function to secure the front pane against slipping and to protect the inside of the frame against dust.

### BRIEF DESCRIPTION OF THE DRAWINGS

Below, the invention is described in detail with reference to drawings, in which

FIG. 1 is a sketch illustrating the principle design of an adapter consisting essentially of a front pane and a frame,

FIG. 2 is a detail of a cross section of the 2D display screen originally intended for two-dimensional image display, and

FIG. 3 is a detail of a cross section of the converted 3D display screen now suitable for three-dimensional image display.

### DETAILED DESCRIPTION OF THE DRAWINGS

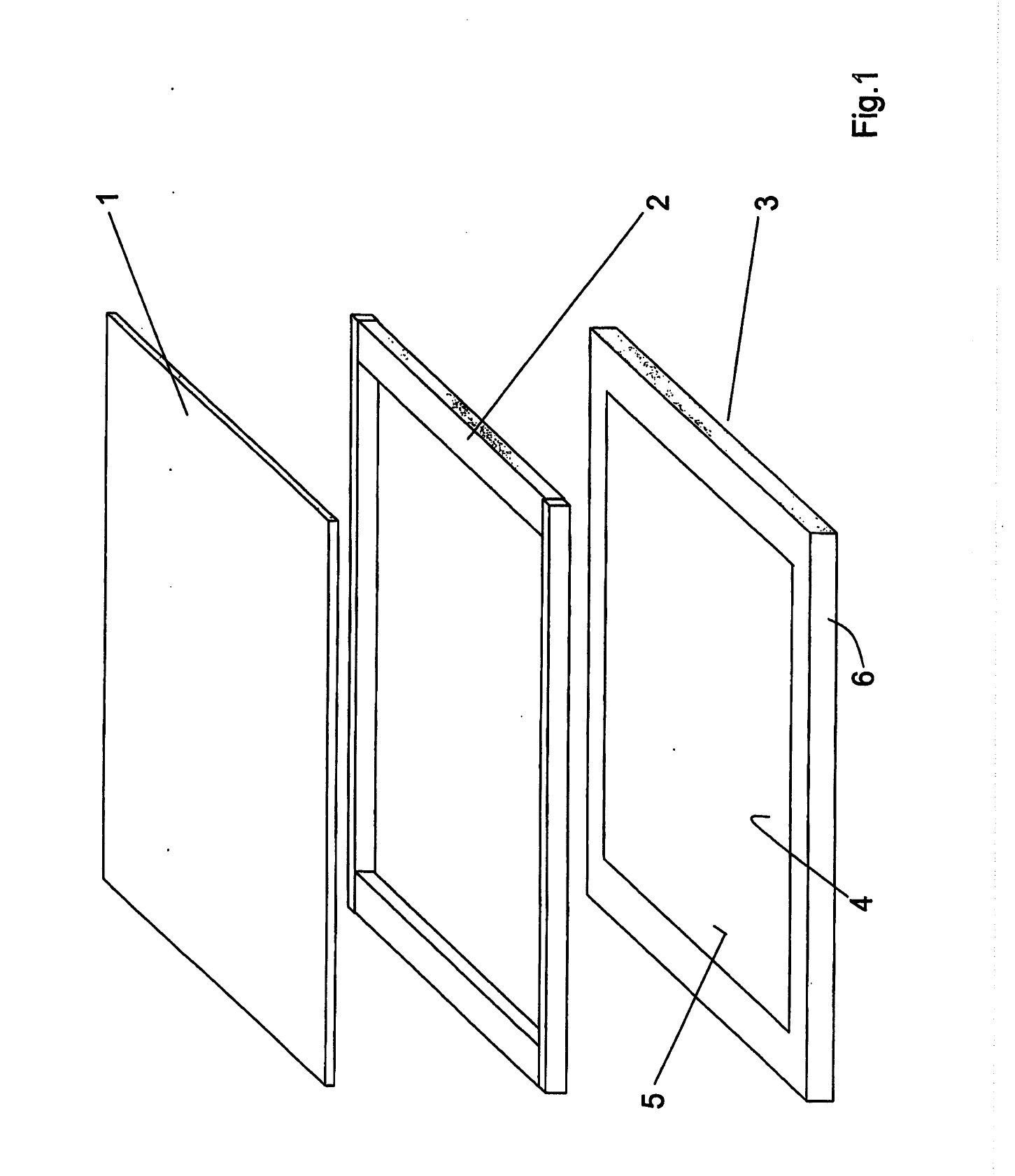

For the sake of clarity, FIG. 1 shows the individual components or component groups separated from each other, although in reality they are arranged in close contact.

The adapter intended for conversion comprises:
a front pane 1, which is provide with at least one optical structure that effects image separation for autostereoscopic display,
a polygonal, preferably rectangular frame 2, made preferable of aluminum profiles, and
means (not shown by the drawing) for either slack or rigid fastening of the front pane 1 to the frame 2, consisting in a layer of adhesive or metal spring clips.

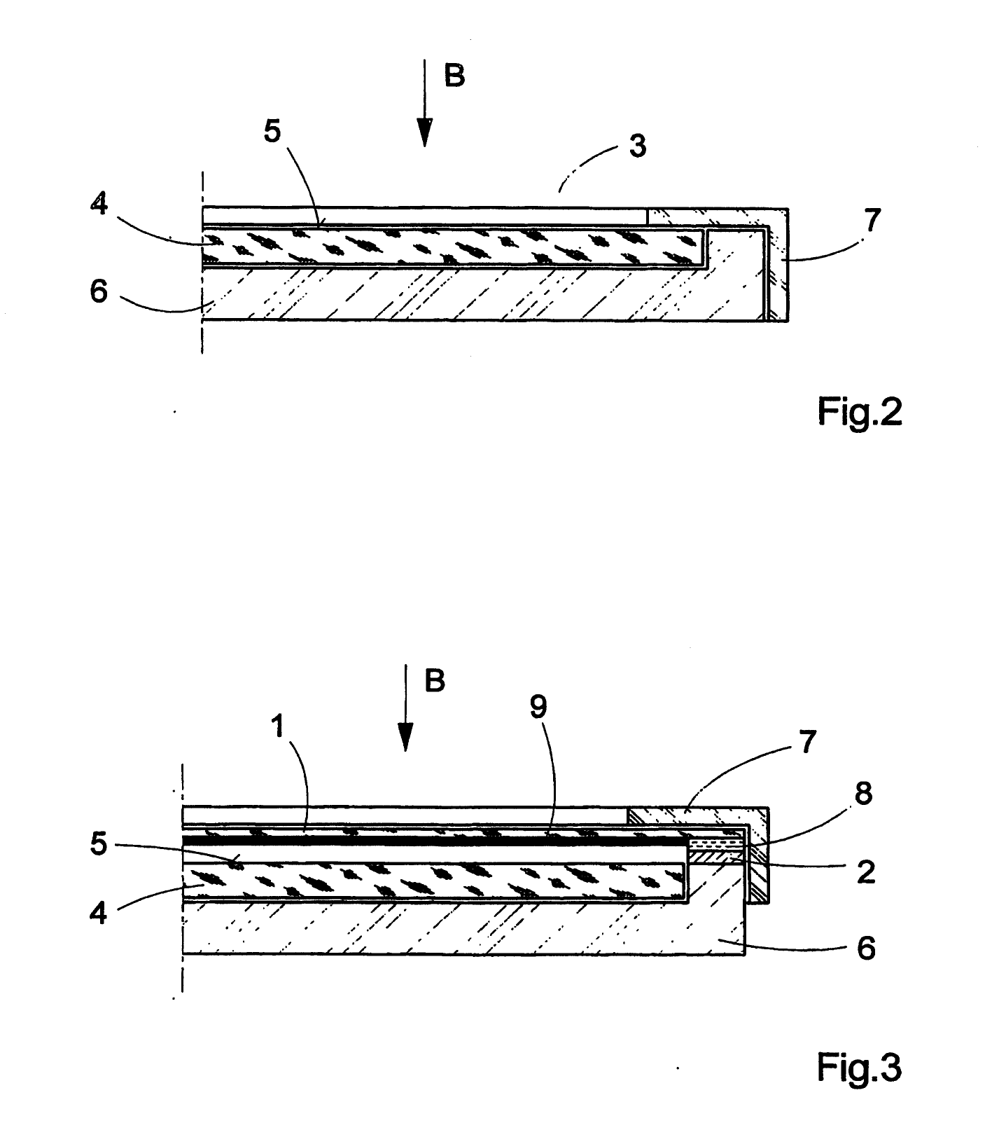

Further, FIG. 1 schematically illustrates a 2D display screen 3, consisting essentially of a plasma display 4 provided with an image display surface 5, and an enclosure or chassis 6. The 2D display screen 3 is shown here with the front bezel 7 (see FIG. 2) removed.

The front pane 1 preferably consists of shatterproof glass and is provided with a planar, electrically conductive structure (not shown). This front pane may be, e.g., a plasma display protection pane as made by Europtec/MMG of Goslar.

The 2D display screen 3 to be converted into a screen suitable for 3D display may be, e.g., a Pioneer PDP 503 plasma screen.

The optical structure that effects image separation for autostereoscopic display may be designed, e.g., as a wavelength filter array 9 (see FIG. 3) as described in DE 201 21 318 U and DE 101 45 133 C1.

With such an optical structure designed as a wavelength filter array 9 and an image combined from several views and displayed on the image display surface 5, an excellent 3D impression is achieved for several observers at a time. For the principle mechanism for creating the optical impression and for dimensioning the wavelength filter array 9, we refer to the above utility model application DE 201 21 318 U.

FIG. 2 shows a detail of a cross section of the 2D display screen 3 originally intended for two-dimensional image display. The illustration symbolically shows those components of the display only that are essential in the context of the invention.

The illustration shows the chassis 6 that accommodates a plasma display 4. The plasma display 4 has an image display surface 5 viewed by an observer (not shown) from the viewing direction B. The image display surface 5 is seen by the observer as a rectangle framed by a front bezel 7. The front bezel 7 is made, for example, of angled metal section as shown in the cross-section, with one leg of the angle covering a marginal zone of the plasma display 4 and the other leg overhanging a lateral surface of the chassis 6.

FIG. 3 shows the components of the 2D display screen 3 shown in FIG. 2, supplemented by an adapter consisting of a frame 2 and a front pane 1 with the wavelength filter array 9 laminated to it.

The frame 2 rests on the chassis 6 with one side and is connected with the front pane 1 on the other. This connection may be established by an elastic layer of adhesive 8, as shown here for example. It is also feasible to provide, instead of the adhesive layer, a thin, elastic lining of rubber, e.g., expanded rubber, and to clamp front pane 1, rubber lining and frame 2 together by means of pre-stressed metal spring clips.

As shown in FIG. 3, the converted 3D display screen, now suitable for autostereoscopic image display, has been provided again with the front bezel 7 that had first been removed from the 2D display screen 3. Now again, the front bezel 7 is arranged so as to partially cover the front pane 1, concealing its margin.

The invention has the particular advantage that it allows 2D display screens of different makes to be converted into 3D display screens, almost irrespective of the design of the chassis 6 and the front bezel 7.

Moreover, the invention permits easy adjustment of the adapter and/or the front pane 1 bearing the optical structure, relative to the image display surface 5, in order to achieve the optimum 3D effect.

1-10. (canceled)

11. A method for fabricating a 3D display screen suitable for the autostereoscopic display of images from a 2D display screen originally for two-dimensional image display comprising an image display surface and a front bezel framing the image display surface,
comprising the steps of:
removing the front bezel from the 2D display screen;
attaching an adapter including an optical assembly for separating an image displayed on the image display surface into stereoscopic partial images, so that the optical assembly covers the image display surface;
aligning the optical assembly relative to the image display surface so that at least one stereoscopic partial image reaches one eye and at least one other stereoscopic partial image reaches the other eye of an observer, who thus perceives a stereoscopic vision of the image displayed.

12. A method as claimed in claim 11, wherein the step of aligning the optical assembly with the image display surface further comprises the step of:
varying a position of the optical assembly jointly with the frame relative to the image display surface, or
varying the position of the optical assembly relative to the image display surface and relative to the frame.

13. A method as claimed in claim 11, wherein the step of aligning the optical assembly with the image display surface further comprises the step of:
displaying a test image on the image display surface, in which the test image is an image combined from n (n≧2) views arranged in rows and/or columns, and in which exactly (n−1) of the views correspond to a completely black area each and exactly one view corresponds to a completely white or completely blue or completely green or completely red area,
continuously displacing a position of the optical assembly relative to the image display surface, with simultaneous visual or opto-electronic inspection of the monocular images from an arbitrary but permanent monocular viewing position until the displacement has led to such a position of the optical assembly relative to the image display surface in which an image selected from the following group is visible in the monocular image seen from the monocular viewing position:
a white area of maximum extension,
a blue area of maximum extension,
a green area of maximum extension, or
a red area of maximum extension.

14. A method as claimed in claim 11, wherein the front bezel, or an alternate front bezel, is attached so that it covers a marginal zone of the adapter.

15. An adapter for making a 3D display screen suitable for autostereoscopic image display from a 2D display screen originally for two-dimensional image display, in which the 2D display screen comprises an image display surface and a front bezel framing the image display surface, the adapter comprising:
a frame whose geometric extension parallel to the image display surface approximately equals an extension of the front bezel of the 2D display screen,
a front pane including an optical structure in the form of an array of wavelength filters, lenticulars or in the form of a barrier screen, that separates an image displayed on the image display surface into stereoscopic partial images, thus implementing image separation for autostereoscopic display, wherein
a margin of the front pane is connected to the frame by fastening.

16. An adapter as claimed in claim 15, wherein the optical structure comprises a wavelength filter array laminated to or printed on the front pane.

17. An adapter as claimed in claim 15, wherein the front pane is fastened to the frame by metal spring clips or an adhesive joint.

18. An adapter as claimed in claim 15, wherein the frame comprises two adhesive surfaces, with one adhesive surface being used for fixation to the outer rim of the screen and the other adhesive surface holding the front pane.

19. An adapter as claimed in claim 15, wherein the frame has a profile depth of between about 2 mm and about 30 mm, so that the front pane including the optical structure that effects image separation is held at a defined distance from the image display surface. the defined distance being defined by the profile depth.

20. An adapter as claimed in claim 15, wherein the front pane comprises shatter resistant glass and a planar, electrically conductive structure that shields observers from electromagnetic radiation.
